(19) United States
(12) Patent Application Publication
(10) Pub. No.: US 2013/0060641 A1
(43) Pub. Date: Mar. 7, 2013

(54) PROMOTIONAL CONTENT PROVIDED PRIVATELY VIA CLIENT DEVICES

(71) Applicant: Faisal Al Gharabally, San Francisco, CA (US)

(72) Inventor: Faisal Al Gharabally, San Francisco, CA (US)

(21) Appl. No.: 13/487,045

(22) Filed: Jun. 1, 2012

Related U.S. Application Data
(60) Provisional application No. 61/492,313, filed on Jun. 1, 2011.

(51) Int. Cl. G06Q 30/02

(52) U.S. Cl. 705/14.66

(57) ABSTRACT

Techniques are described for providing a promotional content server system for conditionally displaying promotional content to qualified users of client devices. In certain situations, advertising providers are enabled to remotely create and configure promotional offers via interactions with the promotional content server system. Information related to each offer is encoded as a promotional package and stored on client mobile devices of users, including in some situations to protect the stored packages to prevent unauthorized access to the offer or its associated terms and rewards. A client-side software module on a user's mobile device determines whether the user qualifies to receive the offer for a package based at least in part on private information stored on the client device, without making such information externally available. If the user is qualified, the client-side module displays an indication of the offer to the user on the mobile device.

### CROSS-REFERENCE TO RELATED APPLICATIONS

This application claims the benefit of U.S. Provisional Patent Application No. 61/492,313, filed Jun. 1, 2011 and entitled “Personalized Promotional Mobile Display System,” which is hereby incorporated by reference in its entirety.

### TECHNICAL FIELD

The following disclosure relates generally to techniques for providing information to users of client devices, such as to conditionally provide promotional offers and other material to qualifying users of mobile client devices while protecting private data of the qualifying users.

### BACKGROUND

Increased competition in the digital marketing industry has led to rapid innovation. Digital marketing has grown from static advertising on Web sites to interactive and personalized advertising, based on data associated with the particular individual to which the advertising is displayed. Marketers and advertisers have also become increasingly interested in building individualized profiles for users by aggregating as much information as possible regarding the users. In addition, marketers and advertisers have become increasingly interested in providing advertisements to users on diverse platforms, including mobile devices of users.

### BRIEF DESCRIPTION OF THE DRAWINGS

FIG. 1 is a network diagram illustrating an example embodiment of interactions that involve configuring and presenting conditionally available promotional content for mobile device users.

FIG. 2 is a block diagram illustrating example computing systems suitable for executing an embodiment of a system for configuring and presenting conditionally available promotional content for mobile device users.

FIG. 3 is a flow diagram of an example embodiment of a Promotional Package Manager routine.

FIG. 4 is a flow diagram of an example embodiment of an Advertising Provider System routine.

FIGS. 5A-5B are a flow diagram of an example embodiment of a Client PCS routine.

### DETAILED DESCRIPTION

Techniques are described for configuring and presenting conditionally available content for users of client devices. In at least some embodiments, the described techniques include providing promotional offers and other promotional content to qualifying eligible users of mobile client devices, while protecting private data of the users from advertisers and other third-parties.

In at least some embodiments, the described techniques include providing a promotional content server system, such as to act as an advertising and marketing platform for conditionally providing promotional offers, advertising content or other promotional content to qualified eligible users of client devices (e.g., network-enabled client mobile computing devices). The promotional content may in at least some embodiments be distributed in a defined package to the client devices of various users, with such a defined promotional package including one or more specified eligibility criteria for use in identifying users that are eligible to receive the offer or other content included in or otherwise associated with the defined promotional package, and with the defined promotional package having one or more associated rewards for eligible users who accept the offer or other content. In addition, in at least some embodiments, a defined promotional package may be encrypted or otherwise protected in one or more manners to prevent modification and/or to prevent some or all of the contents of the defined promotional package from being accessible to users who are not eligible, such as before or during storage of the defined promotional package on one or more client devices.

In addition, each client device may execute software that performs automated determinations of whether a user of the client device qualifies to receive the included offer or other content for each of one or more defined promotional packages. The determination of whether such a user qualifies to receive the offer or other content included in such a defined promotional package may in at least some embodiments be made based on private user-specific data that is stored on the mobile device or otherwise available to the mobile device, including information about various tracked activities of the user. When a user accepts or otherwise selects a defined promotional package for which they are eligible (e.g., including in some situations to pay an associated fee), the automated operations of the software on the client device may further perform activities to provide the user with access to the rewards associated with the defined promotional package (e.g., a free or reduced-cost coupon or voucher for a particular retailer, access to promotional content included within the package, etc.).

Thus, at least some of the described techniques may be performed by automated operations of software executing on a client device of a user in at least some embodiments, and at least some of the described techniques may be performed by automated operations of a promotional content server system that is remote from client devices (e.g., a network-accessible promotional content server system that manages the providing of promotional content to appropriate users on behalf of other advertising providers or other promotional content providers in exchange for fees from the providers and/or from the end users) in at least some embodiments. Additional details related to configuring and presenting conditionally available promotional content are included below.

In at least some embodiments, the one or more client devices of a user may include, for example, one or more of a cellular phone, a smartphone, a tablet computer, a portable gaming device, a portable media player, a network-enabled PDA, a network-enabled laptop or netbook or ultrabook, a desktop device or set-top box device or fixed-location gaming system or other non-mobile device, etc. In certain embodiments, the client devices may be GPS-enabled devices containing GPS receivers, and/or may include other location-aware technology (e.g., based on Wi-Fi location services). As used herein, a client device of a user is intended to broadly describe any hardware (optionally configured with appropriate software) that is designed or configured to perform some or all of the described techniques.

Moreover, in at least some embodiments, a particular client device may store various data (whether in a volatile or non-volatile manner) relating to the location of the device, including the current location of the device, the location history of the device over a certain period of time, a record of particular Wi-Fi networks or other networks with which the device has communicated or which have been available for communication, etc. In addition, various additional user data may be stored on the device (again, either in a volatile or non-volatile manner) relating to the prior activities of the user associated with the device, such as a record of locations that the user has visited (e.g., along with information such as frequency and/or particular associated times or other visit patterns), the user's financial status and history (e.g., retail purchase history, online order history and tracking information, financial institution account history and balances, etc.), media activities (e.g., photographs taken or uploaded to a social network using the client device, videos either recorded or viewed, Internet Web pages that the user has viewed over a period of time, books either downloaded or consumed, etc.), social and social-network activities (e.g., past and current interactions with social networking contacts, media items that the user has recommended or that have been recommended to the user via various social networking mechanisms, etc.), etc. In at least some embodiments, the eligibility criteria of particular promotional packages are based in part or wholly on particular user behaviors (e.g., a particular user action or other activity, a pattern of multiple user actions or other activities, etc.), and the user data for a client device may be analyzed by a client software module on the client device in order to determine particular user behaviors of the user of the client device, for use in determining eligibility of the user for particular promotional packages, as discussed in greater detail below.

In addition, in some situations, a user may use multiple devices at various times, and various private user-specific data for the user may be aggregated on one or more of those devices, to enable use of the aggregated data for determining user eligibility for particular defined promotional packages. For example, in such situations, a particular one of the multiple devices may gather private data for the user from multiple sources (including other of the multiple devices), and aggregate it for use in the user eligibility determinations for particular defined promotional packages. Furthermore, that one device or a different device of the user may be used to display or otherwise make information available to the user about such eligible content, and/or that one device or a different device of the user (e.g., a mobile device of the user) may be used to provide one or more rewards to the user corresponding to an accepted eligible promotional package (e.g., based on the user device being carried to a retail location associated with the rewards, for use in obtaining access to the rewards while at that retail location).

In some embodiments, the described techniques are used to assist advertisers or other advertising providers (e.g., an advertisement distribution service or network) in extending promotional offers (such as pricing discounts, free or nearly free exemplary products or services, coupons or vouchers, etc.) to one or more customers or potential customers that meet certain eligibility criteria, such as based on particular types of user behavior from prior user activities, but without extending such offers to other individuals that do not meet those eligibility criteria. For example, the proprietor of a coffeehouse may wish to offer free samples of a particular new beverage only to those customers who have demonstrated user behavior involving having purchased two or more other beverages from the coffeehouse in the previous thirty days. In this manner, by specifying eligibility criteria that include the user having purchased two or more other beverages from the coffeehouse in the previous thirty days, the proprietor may be able to generate demand for the new beverage with his existing customers, without unnecessarily providing free samples of the beverage to other individuals who do not patronize the coffeehouse. As another example, the proprietor of the coffeehouse may wish to offer a voucher for a free large beverage to individuals who have demonstrated user behavior involving having purchased two or more similar beverages from one or more of the coffeehouse's competitors within the previous three months, such as competitors within a defined range of the coffeehouse or other defined area. Such an offer, with specified eligibility criteria that include the user having purchased two or more similar beverages from one or more of the coffeehouse's competitors within the previous three months, may be effective in converting his competitor's patrons to valuable customers of the coffeehouse. Furthermore, while offering free beverages to selectively tailored groups such as those described above may be an effective advertising practice, extending a similar offer to the population at large may prove both less effective and more costly. Moreover, an advertiser may further desire to limit the number of such offers so extended in order to gain more control over the costs incurred by such offers. For example, instead of offering free samples of a new beverage to all customers who have purchased two or more other beverages from the coffeehouse within the last month, the proprietor may choose to offer only a finite specified number of such free samples (such as to the first fifty qualifying customers to redeem a voucher for the free beverage, or to the first fifty customers who have purchased two or more other beverages from the coffeehouse within the last month and have satisfied one or more other criteria), or to limit the number of such offers made to a defined rate, such as a specified number of offers per specified period of time. In other embodiments and situations, the promotional content of a defined promotional package may be the content itself, such as, for example, a song or other audio data, a photo or image or video data, a game or other software program, or access to other specified information.

In certain embodiments, a promotional content server system is provided to allow the configuration, storage and dissemination of promotional offers and other promotional content (herein referred to generally as “offers”) for conditional display to qualifying users of client devices. Each offer, along with its associated specified eligibility criteria (e.g., terms and conditions) and any associated customer rewards, may be specified in a defined promotional package by the operator of the promotional content server system or its advertising provider partners (either remotely or locally) in various manners (such as via an application programming interface or “API” provided for interacting with the promotional content server system programmatically, via a graphical user interface or “GUI” similarly provided, or some combination thereof). In at least some embodiments, information related to each offer (which may include any or all of the eligibility criteria and rewards associated with the offer, information related to the advertising provider submitting the offer to the promotional content server system, location information related to the site or sites at which one or more associated rewards may be redeemed, or other information) may be stored by the promotional content server system after being compressed, encoded and/or encrypted into a secure promotional package suitable for broadcast, wired or wireless transmission, download and storage by one or more client mobile devices. In addition, in at least some embodiments and situations, a particular promotional package may include multiple offers or other promotional content, such as alternatives with different specified eligibility criteria, as discussed further below.

A defined promotional package may be received by one or more client devices in a variety of manners. In certain embodiments, one or more such promotional packages may be broadcast by a promotional content server system using available broadcast channels, such as those provided by a regional cellular network and/or by one or more Wi-Fi host spots (e.g., within beacon messages transmitted by a Wi-Fi transmission device that are available to any Wi-Fi enabled device in range), or may be otherwise pushed to some or all client devices (e.g., to particular client devices that have previously registered with the promotional content server system). In some embodiments, packages are downloaded by a client device from a promotional content server system at regular intervals or in response to one or more precipitating events or conditions, such as by pulling or otherwise requesting that information from the promotional content server system. In addition, in some embodiments, some or all client devices of users may execute software (e.g., a software module provided by the promotional content server system) that contacts the promotional content server system to download or otherwise obtain promotional packages, such as periodically or upon request by the user of a mobile device. Furthermore, the download of a promotional package to a mobile device may in some embodiments and situations occur in multiple parts, such as to initially download information about the specified eligibility criteria for the multi-part promotional package, and to later download other information for the promotional package (e.g., only if the user qualifies to receive the offer or other promotional content included in the promotional package, only if user accepts or otherwise selects to receive the reward(s) associated with the offer or other promotional content, etc.). The download of a particular promotional package to a particular client device may also be triggered in various manners in various embodiments, including based on triggering criteria specified as part of the promotional package in at least some such embodiments, such as by location of a mobile client device, current characteristics of the user of the client device, a current time or other current conditions not specific to the client device or its user, etc.

In certain embodiments, once one or more defined promotional packages are received by a client device, the promotional packages are stored within the client device in an encoded (and possibly encrypted) manner by a software module provided by the operator or affiliate of the promotional content server system that is being executed on the client device—for example, all such received promotional packages may be stored for a least a minimum period of time in some situations, while in other situations a promotional package may be stored only if a user of the client device qualifies for the promotional package based on its eligibility criteria (and optionally may be removed from the client device if it is determined that a user of the client device does not qualify for the promotional package). In at least some embodiments, the promotional packages are encoded and/or encrypted prior to being received by the client device; in other embodiments, they may be encoded and/or encrypted by a software module executing on the client device. Because the promotional packages are stored in such a manner, unauthorized access to the information associated with a given promotional package (e.g., by the user of the client device, by other software executing on the client devices, by other third party entities, etc.) may be prevented, while the software module may decrypt or otherwise decode promotional packages when the contents are to be accessed (e.g., by having each software module on a client device be configured with a distinct private encryption key, such as part of a public-private encryption key pair and with the promotional content server having access to the corresponding public encryption key; by having all software modules on client devices be configured to share a common private encryption key; etc.). Preventing such unauthorized access may be desirable in order to, for example, prevent a user of the client device from attempting to redeem rewards associated with an offer for which she is unqualified, or for which she artificially qualifies after fulfilling the prerequisite eligibility criteria of the offer in a manner which she otherwise would not have performed. Moreover, preventing such unauthorized access may also be desirable in order to prevent a competitor from learning of details associated with the supplying advertising provider's offer, or for other reasons.

In at least some embodiments, for each of the promotional packages stored on the client device, the software module being executed on the client device determines whether the user associated with the client device has satisfied the prerequisite eligibility criteria associated with the promotional package, and therefore whether to display information associated with the promotional package and its associated rewards to the user, or to otherwise provide the user with access to such rewards. In certain embodiments, this determination is performed by the same software module that manages the receiving and storing of the defined promotional packages on the client device. The determination of the user's eligibility with respect to each promotional package is based at least in part on private information stored on or otherwise accessible the client device that is retrieved by the software module. In certain embodiments, for example, if the promotional package was received by the client device in response to a precipitating event, the determining software module may attempt to determine if the user is qualified to receive the offer indicated by the received promotional package upon receiving the package, or within a predetermined time after receiving the package. In at least some embodiments, the determining software module may attempt to make such a determination at regular intervals, or may attempt to do so in response to a precipitating event such as those described in greater detail elsewhere (e.g., a payment-based event, an application-based event, a location-based event, an optical or imaging event, or some combination of any of these). In yet other embodiments, the determining software module may track which activities of the user (or other information) are needed to qualify the user for a particular promotional package (optionally making such information available to the user), and notify the user of a promotional package for which the user is eligible once those user activities occur.

A variety of user data stored on or accessible to a client device may be examined by the client software module in order to determine whether the user qualifies to receive one or more offers or other promotional content indicated by promotional packages stored on the client device. Non-limiting examples of user data may include the location or location history of the device, either with respect to the lifetime of the device or a specific period of time; the user's current or past financial status and purchasing transaction history; current or past interactions with one or more social networks; Web browsing history; photographs, videos, books or other media stored on the client device, etc. The client software module may, for example, access private user data that it has previously stored, or may in addition or instead access private user data that was previously stored or is currently available from one or more other application programs executing on the client device—for such application-specific data, the promotional content server system may, for example, provide a library of application-specific data formats or data access software that may be used by the client software module to access such application-specific data from storage or via interactions with the application, or some or all client software modules may be otherwise configured to use such application-specific data formats or data access software. In addition, in some embodiments a user may have multiple client devices (e.g., a mobile device and a non-mobile device, two mobile devices, etc.), and private user data from multiple such client devices may be aggregated. Furthermore, in some embodiments and situations, a client software module may be configured to access one or more external sources of data that store confidential data related to the user (e.g., services or systems with which the user has an account), including financial institutions, social networking sites, etc. Determination of a user's eligibility for a particular offer may also in some embodiments be made by using data mining techniques with respect to the private information available to the client device, such as to determine patterns or other aggregated information that is used to satisfy eligibility criteria for one or more defined promotional packages. Furthermore, in some embodiments and situations, certain promotional packages may be automatically selected to be filtered and not indicated to the user (even if the user is eligible for some or all such promotional packages), such as by the client software module using user preference data or other private user data. In such embodiments where the determination of the user's eligibility is made by a software module executing on the client device, based on private user data that is stored on the client device and with respect to a promotional package that is also stored on the client device, the private user data used to determine whether the user satisfies the eligibility criteria is not transmitted or otherwise externally conveyed from the client device (or is otherwise protected so that it is not made accessible to entities other than the user and any other entities that are designated by the user as being authorized). In this manner, the privacy of the user associated with the client device and the user's private user data may be preserved.

In at least some embodiments, if it is determined that the user of a client device qualifies to receive a particular offer indicated by a promotional package or other reward associated with the promotional package, information related to the offer or other reward is displayed to the user on the mobile device. In certain embodiments, the displayed information may thus include an indication of one or more of the rewards associated with the promotional package, and may further include instructions as to how to redeem or otherwise use or access the indicated one or more rewards. Optionally, the displayed information may further indicate why the user has qualified to receive the reward (such as by displaying an indication of the behavior or transaction rendering the user eligible). Moreover, in certain embodiments, a unique redemption token may be generated and displayed to the user for purposes of redeeming the associated reward, such as a token to be provided to an associated online merchant or physical merchant location. In addition, in certain embodiments, information for use in redeeming an offer or otherwise obtaining access to a reward may be presented via a visual barcode (e.g., a QR code, or Quick Response code) or other code displayed on a screen of the client device, such as for scanning by or other display to a particular merchant via a mobile client device. In at least some embodiments, the client device may communicate with one or more components of the originating promotional content server system to indicate that eligibility for a particular promotional package has been displayed to or otherwise provided to a user and/or has been redeemed or otherwise used or accessed by a user of the client device, such as in a manner to allow the promotional content server system to track how many users have qualified to receive a particular offer (e.g., without the identity of those users being known), how many users have redeemed the rewards for a particular promotional package (e.g., without the identity of those users being known), etc.

Thus, the use of the described techniques may provide various benefits in particular situations and embodiments. As one example, private user data for a user may be protected, while enabling the user to nonetheless receive offers and other promotional content for which the user is eligible—thus, not only may such a user remain anonymous, but some or all private user data stored on the client device may be protected from access by any entities other than the user (e.g., for some part of the process, such as until the user redeems an offer or otherwise accesses a reward associated with an accepted promotional package; at all times, including before, during and after the user redeems an offer or otherwise accesses a reward associated with an accepted promotional package; etc.). As another example, advertising provider users may be able to more easily target their offers or other promotional content to users of interest, with the users who receive the offers or other promotional content being determined to satisfy specified eligibility criteria, and with the group of possible users from whom to identify eligible users being larger than would otherwise be available (e.g., based on more users participating in the system since their private user data is protected). It will be appreciated that other benefits may similarly be achieved by use of the described techniques, some of which are described herein.

For illustrative purposes, some embodiments are described in which particular types of offers or other promotional content relating to products or services marketed by the operator of a promotional content server system or its advertising provider partners are conditionally displayed to users of particular types of client devices (e.g., mobile devices) based at least in part upon the information stored on, or otherwise available to, the client devices. These examples are provided for illustrative purposes and are simplified for the sake of brevity, and the inventive techniques can be used in a wide variety of other situations, some of which are discussed below.

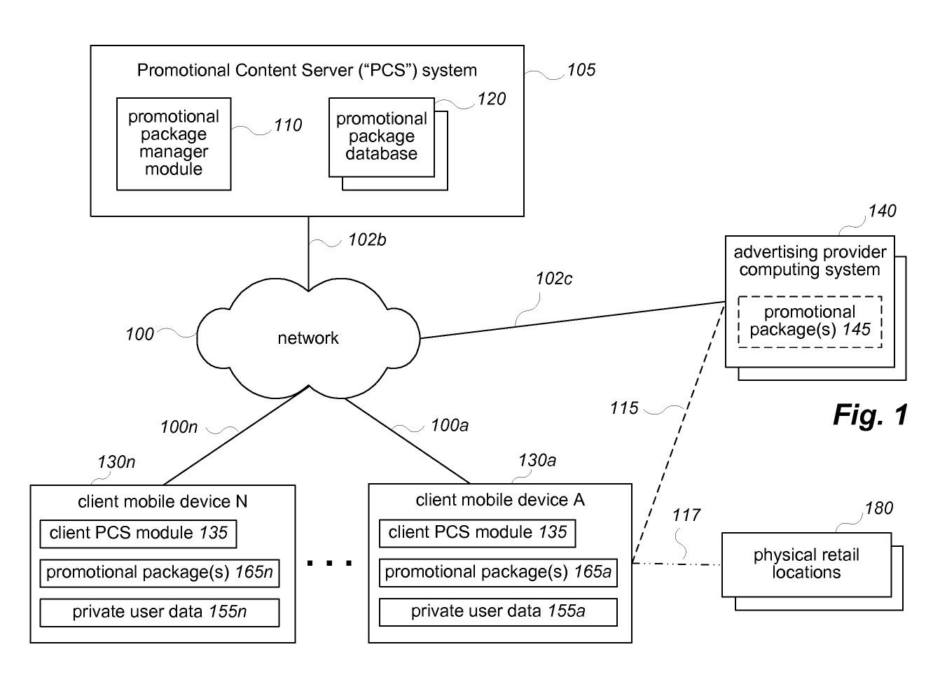

FIG. 1 is a network diagram illustrating an example embodiment of a promotional content server system that enables remote advertising providers to create and configure offers and other promotional material for the dissemination and conditional display to the users of one or more client mobile devices. In this example, promotional packages are created in response to an offer being created and configured by an advertising provider partner of the operator of a promotional content server system 105, which provides such functionality to the advertising provider (not shown) over one or more public and/or private networks 100 (e.g., over network interconnections 102b and 102c). Thus, the remote advertising providers may use their computing systems 140 to interact with the promotional content server system 105 and dynamically create and configure an offer that is encoded and/or encrypted into a promotional package for broadcast, download, or other transmission to one or more client mobile devices 130.

In particular, in the example of FIG. 1, a number of advertising providers are using their respective computing systems 140 to interact over a network 100 with a promotional package manager module 110 of the promotional content server system 105 to create and configure a number of promotional packages (e.g., stored within database 120) that each includes information related to the eligibility criteria and rewards associated with at least one promotional offer. The promotional content server system 105 includes the promotional package database 120 for storing the configured promotional packages, while in some embodiments and situations, some or all advertiser provider computing systems 140 may optionally store at least some of their own defined promotional packages 145 themselves (whether in addition to or instead of the PCS system 105). In at least some embodiments, the promotional package manager module 110 may execute on one or more computing systems, and may provide one or more APIs that enable the remote advertising provider computing systems 140 to programmatically interact with the promotional package manager module 110 to access some or all functionality of the promotional content server system 105, either on their own behalf or on behalf of third-party advertisers (e.g., to create, configure, and/or initiate the dissemination of promotional packages generated by the promotional package manager module 110 (such as in response to offer information submitted by advertising providers) and stored within the promotional package database 120. In addition, in at least some embodiments, advertising providers may instead manually interact with the promotional package manager module 110 (e.g., via a user interface, such as a graphical user interface or “GUI,” provided by the promotional package manager) to perform some or all such actions.

The network 100 may be, for example, a publicly accessible network of linked networks (whether wired and/or wireless networks), possibly operated by distinct parties, such as the Internet, and may also optionally include one or more private networks, such as those made available to customers of a private cellular telephone network. The client mobile devices 130 may have either transitory or permanent access to one or more such networks.

Each mobile client computing device 130 receives one or more promotional packages 165 from the promotional content server system 105 and the promotional package database 120 over the network 100 (e.g., via network interconnections 102b and respective interconnections 100X) at various times and in various manners, including for different client devices (e.g., client devices 130a and 130n) to receive the same or different promotional packages 165a and 165n, respectively. Furthermore, even if two client devices receive the same (or overlapping) promotional packages, the packages that are subsequently retained on storage of the client devices may differ over time (e.g., based on one or both client devices filtering and removing certain promotional packages on that client device before or after eligibility determinations; based on acceptance or other selection of particular promotional packages on a particular client device; etc.). For example, a client software module 135 of the promotional content server (“PCS”) system executing on each client device may receive a promotional package from a broadcast transmission; may poll the promotional content server system 105 at regular intervals or some other schedule over network 100 in order to download or otherwise receive promotional packages fulfilling certain criteria; or may download or otherwise receive promotional packages in response to certain precipitating events being triggered by one or more triggering criteria. As one example, if a particular type of triggering criteria is satisfied (e.g., based on device location; current time, such as to be satisfied periodically; etc.), the device may be triggered to enable a transmission receiver on the device or otherwise monitor for any broadcast signals or other available signals (e.g., an acoustic signal transmitted within a retail location) that include any defined promotional packages (e.g., packages relevant to a current location and/or time). These precipitating triggering events and criteria may include, for example, a payment-based trigger (such as when a user executes a particular financial transaction with a participating retail outlet or the outlet of an advertising provider's competitor), an application-based trigger (for example, a user associated with the client device interacting in a predefined manner with a social media application or other application on the client device, such as sending/receiving a message containing a predefined term), a location-based trigger (such as a user of the client device entering or leaving a predefined geographical region, or traveling within a predefined radius of a retail outlet associated with an advertising provider or the advertising provider's competitor), an optical or imaging trigger (e.g., the client device being used to view or capture an image of a predefined visual code, such as a two-dimensional or three-dimensional barcode), or various combinations of these and other events. Of course, it will be appreciated that a wide variety of precipitating triggering events and criteria may be selected for the purpose of receiving one or more promotional packages, or for initiating the performance or other actions and providing of corresponding other functionality by the client software modules or other automated systems described herein.

In addition, in certain embodiments, a client mobile device 130 may receive one or more optional promotional packages 145 directly from computing system(s) 140 of one or more advertising providers, such as if the user of the client device enters or passes by an advertising provider's retail establishment (not shown) and receives the promotional packages as part of a broadcast initiated by the advertising provider over transmission link 115 and/or 117, if the user requests such promotional packages from the system 140, etc. As another example, a client device 130 may receive a promotional package using other receptive capabilities of the client device, such as Bluetooth communications, near-field communications or “NFC,” radio-frequency identification or “RFID” communications, etc., such as while at or near a physical retail location 180 associated with one or more particular advertising providers.

In the illustrated embodiment, after a promotional package has been received by a client computing device 130, the client software module 135 determines the eligibility criteria associated with the offer or offers indicated by the promotional package (such as by decoding and/or decrypting the promotional package, if necessary). The client software module 135 is configured to access and utilize information stored on its client device 130, such as private user data 155 (e.g., information associated with the user of the client device, information related to the location history of the client device, or other information) to determine whether the user of the client device fulfills the eligibility criteria associated with the relevant offer. The client software module 135 may attempt to make this determination immediately after decoding and/or decrypting the promotional package, at regular or other predetermined intervals, in response to one or more precipitating triggering events or triggering criteria as described elsewhere, or on some other schedule. In some embodiments and situations, the private user-specific user data for a client mobile device may include information about visits of the mobile device and its user to one or more particular physical relation locations 180, such as location-based information and/or transaction-based information.

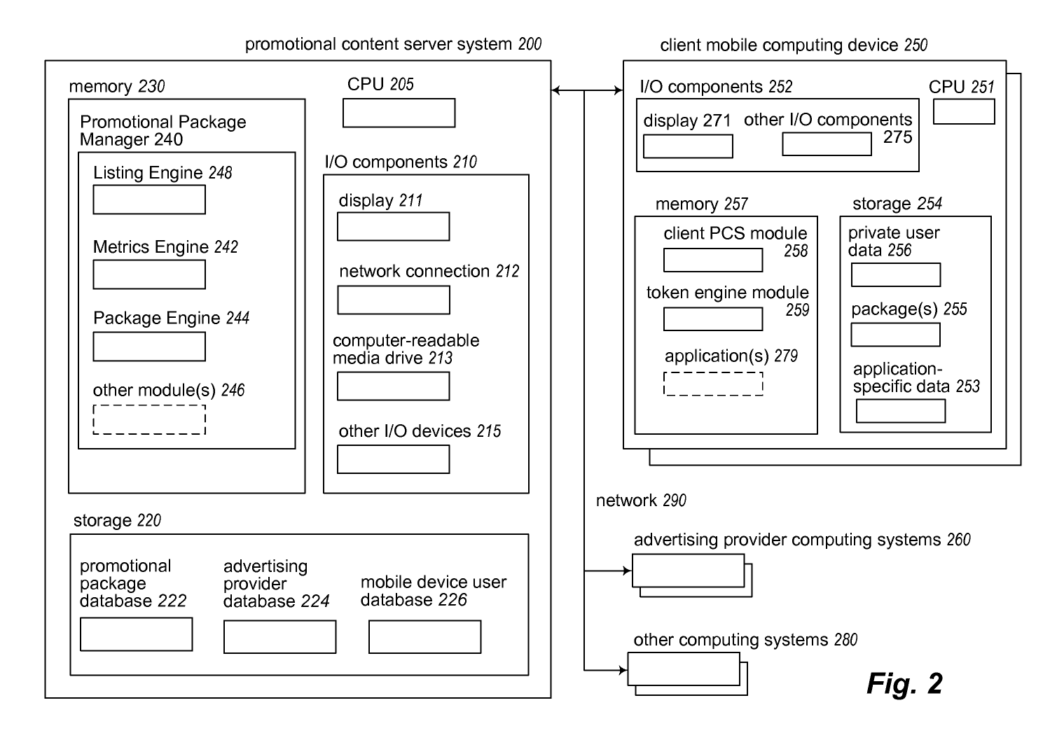

If the client software module 135 determines that the user of its client mobile computing device 130 qualifies to receive the offer associated with a particular promotional package, the client software module displays or otherwise provides to the user an indication of the offer and its associated rewards, such as on a display (not shown) of the mobile device (e.g., a display 271 of a client device 250 of FIG. 2) and/or on another client device of the user. In certain embodiments, this indication may include a unique redemption token generated for the user (e.g., by the client software module, or by other associated software on the client device, such as token engine module 259 on client device 250 of FIG. 2) to be used to redeem the rewards associated with the offer. In other embodiments, the indication may not include a unique token, but may include other instructions for redeeming the rewards, including instructions to visit one or more particular physical relation locations 180 to redeem the rewards. Depending on the configuration of the promotional package, the user may also receive an indication of the eligibility criteria fulfilled by the user that rendered them eligible to redeem the rewards.

In certain embodiments, the client software module 135 may send certain information from its client mobile device 130 to the promotional content server system 105. For example, the client software module 135 may acknowledge the receipt of one or more defined promotional packages; may send an indication that an offer has been displayed to the user; may send an indication that one or more rewards associated with an offer has been redeemed by the user; etc. Information stored on the client device 130 used by its client software module 135 to determine whether the user qualifies to receive any particular offer, such as private user data 155, is not transmitted to the promotional content server system 105 or otherwise made available externally to the client device in at least some embodiments. In some embodiments, each client device 130 may include a copy of the same client software module, while in other embodiments different client devices may have different client software modules (e.g., different versions, different software specific to a type of the client device and/or a type of the operating system software on the client device, etc.).

FIG. 2 is a block diagram illustrating example computing systems suitable for executing an embodiment of a system for configuring and presenting conditional content for client device users based on information submitted by advertising providers. In particular, FIG. 2 illustrates a promotional content server system 200 suitable for executing an embodiment of a promotional package manager module 240 (e.g., the same or similar module as module 110 of FIG. 1) that assists in enabling advertising providers to create, configure and initiate dissemination of promotional packages indicative of one or more conditional offers using either advertising provider computing systems 260 or other computing systems 280. Once dissemination of a defined promotional package has been initiated, it may be transmitted to one or more client mobile computing devices 250 via a network 290. The network 290 may include both publicly-accessible networks or collections of such networks such as the Internet and/or the World Wide Web, whether wired and/or wireless, and may also include one or more private networks, such as private cellular telephone networks or private local-area networks (“LANs”). While not illustrated here, in some embodiments the promotional content server system 200 may include multiple computing systems, some or all of which may be co-located or otherwise associated, while others of which may be located remotely from other computing systems within the promotional content server system. In addition, while not illustrated here, various other modules of the promotional content server system 200 may be present and used in at least some embodiments, such as various tracking and data-aggregation modules and one or more external communication modules.

In the illustrated embodiment, the promotional content server system 200 has components that include a CPU 205, various I/O components 210, storage 220, and memory 230. The illustrated I/O components include a display 211, a network connection 212, a computer-readable media drive 213, and other I/O devices 215 (e.g., a keyboard, a mouse, speakers, etc.). In addition, the advertising provider computing systems 260 and other computing systems 280 may also each include similar components to some or all of the components illustrated with respect to promotional content server system 200, but such components are not illustrated in this example for the sake of brevity. In addition, the illustrated client mobile computing devices 250 may have components with functionality similar to that of the corresponding elements of promotional content server system 200, including a CPU 251, I/O components 252 (which include display screen 271 and other I/O components 275, which may include some or all of the same types of I/O components 210), storage 254, and memory 257. In the illustrated embodiment, a client PCS software module 258 is executing in memory 257, as well as a token engine module 259 that is part of or otherwise associated with the client software module 258, and optionally one or more other applications 279. Private user data 256 is stored within the storage 254 of the client mobile computing device 250, as well as optionally application-specific data 253 that is generated and/or used by the application(s) 279. Various downloaded packages may also be stored on storage 254 of a particular client mobile computing device 250, such as one or more packages 255.

An embodiment of a promotional package manager module 240 is executing in memory 230, and it interacts with client mobile computing devices 250, advertising provider computing systems 260, and optionally, other computing systems 280 over one or more of the networks 290. In the illustrated embodiment, the promotional package manager module 240 includes functionality related to automatically facilitating the conditional display of promotional offers created by or on behalf of advertising providers affiliated with the operator of the promotional content server system 200. The advertising provider computing systems 260 (and optionally, the other computing systems 280) may also assist in providing and managing the promotional packages, such as enabling the creation and configuration of the offers and their promotional packages, and the submission of configured offer information from advertising providers or other entities to the promotional content server system 200. Each of the client mobile computing devices 250, the advertising provider computing systems 260, and the other computing systems 280 may be executing various software as part of interactions with the promotional content server system 200 or as part of additional functionality performed by these systems, such as to program or otherwise configure CPU processors of those computing systems or devices to perform particular described functionality.

In at least the illustrated embodiment, the promotional package manager module 240 includes various sub-modules, including a listing engine module 248, a metrics engine module 242, a package engine module 244 and optionally one or more other modules 246. In certain embodiments the promotional package manager module 240 may include additional sub-modules intended to support its functionality, may instead combine various of the described functionality in less sub-modules, or may not include at least some of the described functionality.

Listing engine 248 is configured to allow advertising providers to create and maintain information related to their business enterprises, such as GPS coordinates or other location information they wish associated with one or more retail outlets, within the promotional content server system 200. For example, an advertising provider using one of the computing systems 260 may indicate to the listing engine 248 the GPS coordinates of all of the advertising provider's retail outlets within a particular geographic region, along with other relevant location-dependent variables (e.g., information related to Wi-Fi networks available and/or proximate to one or more of the retail outlets), in such a manner as to enable eligible users visiting the advertising provider's retail outlets to redeem rewards associated with that provider's promotional offers.

Metrics engine 242 is configured to collect and aggregate data from client mobile computing devices 250 in response to occurrences related to certain promotional packages. For example, the metrics engine 242 may aggregate data related to the redemption of rewards from one or more particular advertising providers in order to provide information related to the relative effectiveness and cost of various offers associated with those advertising providers. In certain embodiments, metrics engine 242 may also collect data related to the number of promotional packages that were acted upon by users of the client mobile computing devices 250, or other aggregate data related to aspects of promotional package usage, eligibility, display and redemption, either in total or with respect to particular periods of time. In certain embodiments, the metrics engine 242 provides additional functionality with respect to limiting the redemption of offers associated with particular packages based on aggregate information relating to earlier redemptions of the offer or other aggregate information. For example, if a particular promotional package indicates that an offer is only redeemable by fifty users, the metrics engine 242 may cause a secondary package or other package update information to be transmitted to some or all client devices (e.g., client devices to which the particular promotional package is known to have been previously transmitted, client devices associated with otherwise-qualified users, etc.) once the data aggregated with respect to that offer indicates that fifty users have redeemed the associated reward, with the secondary package or other update information indicating that the offer is no longer valid.

Package engine 244 is configured to convert variables, parameters, results and other provider-defined information related to a particular offer and its associated eligibility criteria and rewards into a compressed and encrypted package that may be broadcast, transmitted, downloaded or otherwise sent to the client mobile computing devices 250. For example, a package may include variables and parameters relating to location-based and/or transaction-based triggers by which the user of a client device may qualify to receive an associated offer; one or more location variables related to retail outlets at which a user may redeem the rewards associated with the offer; variables and parameters related to the rewards, such as the value of a coupon or voucher to be provided to a qualified user; an encoding scheme by which a visual code (e.g., a two-dimensional or three-dimensional barcode that may be later recognized by an optical camera or imaging system such as those commonly used by various retail establishments or included in the client devices 250) may be generated for use in redeeming the rewards; and a second encoding scheme for generating a unique token for use in redeeming the rewards.

In certain embodiments, a single promotional package may include variables and parameters configuring or defining multiple related offers, for which a user may qualify either simultaneously, consecutively or alternatively (referred to generally herein as alternative offers). For example, a package may include variables and parameters relating to a first offer for $2.00 off the price of a large beverage at an advertising provider's retail establishment to a user who has spent at least $10 at the establishment in a predetermined time period, with first eligibility criteria for the first offer including that an eligible user has spent at least $10 at the establishment in the predetermined time period, and may also include variables and parameters relating to a second offer for a $5.00 voucher at the retail establishment redeemable by a user who has spent at least $20 at that retail establishment in that same time period, with second eligibility criteria for the second offer including that an eligible user has spent at least $20 at the establishment in the predetermined time period. Thus, such a defined promotional package has multiple offers that each has distinct eligibility criteria—in such situations, the defined promotional package may not have distinct eligibility criteria that are separate from the individual eligibility criteria for the multiple alternative offers, or instead may have such separate eligibility criteria that an eligible user has to satisfy before any of the multiple alternative offers are considered (e.g., separate eligibility criteria that is a minimum set of the distinct eligibility criteria for all of the multiple alternative offers, such as an eligible user having spent at least $10 at the establishment in the predetermined time period for the prior example). If a user qualifies for both offers, the client software module 258 executing on the user's client device 250 may display or otherwise provide to the user an indication of the rewards associated with the first offer, with the second offer, or with both (or more generally with all, even if more than two), depending on the terms and parameters configured by the submitting advertising provider and included in the promotional package. The package engine 244 may also include functionality related to the generation, distribution, and storage of encryption keys or portions thereof.

The token engine module 259 is shown in the illustrated embodiment as executing on the client devices 250, although in other embodiments may instead or in addition operate as one of the optional modules 246 of the server system 200. The token engine module is configured to use a specified encoding and/or encrypting mechanism to generate tokens for the dissemination to users eligible to redeem rewards associated with a particular offer and promotional package. In certain embodiments, the token engine module includes additional sub-modules (not shown) to provide or enhance its functionality with respect to token generation, token communication, and token security. If a particular promotional package includes a scheme for generating a unique token for use in redeeming rewards associated with an offer, the token engine module may utilize the included scheme to generate such a token—for example, such a scheme may indicate a pattern of alphanumeric characters that each such token is to use (e.g., a number of characters, a specified format, etc.), or may otherwise indicate a type of token or a technique for generating the token (e.g., a software applet to be executed to locally generate a token). In embodiments in which the token engine module executes on the server system 200, upon determining that a user qualifies to receive an offer associated with a promotional package that includes a token generation scheme, the client software module 258 executing on a user's client mobile computing device 250 may transmit an indication of eligibility to the promotional content server system 200, and responsive to the transmitted indication, the token engine optional module 246 may generate a redemption token (e.g., a unique token) using the token generation scheme included in the corresponding promotional package and then transmit the generated token to the client device 250. Alternatively, in the illustrated embodiment, the token engine module 259 on a client device 250 may generate the redemption token on the client device 250 based on the token generation scheme included in the promotional package, thus enabling private user data 256 to be further protected.

The client software module 258 may either display the redemption token to the user directly, or may simply provide an indication to the user that the reward associated with the offer is now available to be redeemed at a particular location. In order to redeem the reward, the user travels to the indicated location (such as a retail establishment associated with the advertising provider that has submitted the offer to promotional content server system 200 for dissemination) and uses the client software module 258 to provide the redemption token in exchange for the desired reward. In certain embodiments, the redemption token may take the form of a visual code, or may be representable as a visual code for purposes of providing the redemption token at the time rewards are to be redeemed. Such a visual code may be scanned by a retailer associated with the advertising provider that originally submitted the offer to the promotional content server system 200, at which time the retailer provides the indicated rewards to the user of the client device 250. In certain embodiments, the retailer may scan the visual code using one or both of an advertising provider computing system 260 or other computing system 280, such that an indication that the rewards associated with a particular offer have been redeemed is automatically provided to the promotional content server system 200 and possibly the metrics engine 242. Similar to package engine 244, the token engine module may also include functionality related to the generation, distribution, and storage of encryption keys or portions thereof.

The storage 220 of the promotional content server system 200 includes a promotional package database 222, a mobile device user database 226, and an advertising provider database 224. In at least the illustrated embodiment, the promotional package database 222 is configured to store information related to promotional packages generated for dissemination by the promotional package manager 240, the mobile device user database 226 is configured to store information about registered mobile computing devices and/or their users (e.g., about mobile devices having associated PCS modules), and the advertising provider database 224 is configured to store information related to advertising providers or other entities who have created and/or configured promotional offers to be encoded as promotional packages.

In at least the illustrated embodiment, the client software module 258 executing on a client device 250 is configured to provide various functionality related to receiving and/or downloading promotional packages, either at regular intervals, responsive to one or more predefined precipitating events, or on some other schedule; storing the encoded and/or encrypted promotional packages on the client device in various manners so as to prevent unauthorized access to the promotional packages or information related to the offers associated with such packages; decoding and/or decrypting such stored promotional packages; performing data mining operations on the private user data 256 stored in storage module 254 of the client device; determining whether a user associated with the client device qualifies for each offer associated with a promotional package without making the private user data available externally to the client device; displaying indications to the user regarding the offers and/or rewards for which the user qualifies based on such determinations; providing indications to the promotional content server system 200 related to the display and/or redemption of such eligible offers by a user associated with the client device; and generating, if necessary, redemption tokens and/or visual codes related to the rewards which a qualified user of the client device would like to redeem. In certain embodiments, the client device 250 includes one or more other modules configured to provide portions of such functionality. With respect to the present description, the entirety of such functionality is assumed to be provided by the client software module 258, with token engine module 259 being part of the client software module 258, but it will be appreciated that descriptions related to the actions and functionality of client software module 258 may also apply to other applications and modules providing portions of such functionality.

The private user data 256 (optionally including some or all of application-specific data 253 that is obtained for use by the client software module) is stored within the storage module 254 of the client mobile computing device 250, and may include a variety of information related to one or more users associated with the client device, including e-mail and other messaging history, financial status and history, retail and online purchase history, web browsing history, online interactions and interaction history with one or more third-party networks (e.g., social networks), and media items (e.g., books, music, images, photographs and other images, videos, etc.) either received, stored or transmitted by the user. User data 256 may also include information related to the transaction or behavioral history associated with the client device itself, such as current location or historical location information, or photographs, audio files and other media captured by the client device. In certain embodiments, the client software module 258 may preserve certain aspects of the user data 256 even when those aspects or portions of the user information have been otherwise removed from storage module 254 or from the entirety of the client mobile computing device 250. For example, the user of the client device 250 may elect to delete a portion or the entirety of a purchase transaction history. However, the client software module 258 may create or preserve a record of such transaction history with respect to the retail outlets associated with one or more promotional packages stored on the client device 250, so as to maintain an accurate assessment of the user's eligibility for offers associated with those promotional packages. In this way, even if a user has erased their purchase transaction history for a given month, the client software module 258 may accurately determine that the user qualifies for a reward at a local coffeehouse because the user purchased a requisite number of beverages at that coffeehouse during the indicated month.

Moreover, the client software module 258 may be configured in some embodiments to perform data mining with respect to user data beyond that which is stored on the client mobile computing device 250. For example, the user associated with the computing device may elect to authorize the client software module 258 to access private data of other devices of the user of the device 250 and/or to access certain cloud-based or social networking data that is stored on third-party computing systems. In this way, for example, the client software module 258 may determine that a user qualifies to receive one or more promotional offers based on, for example, the results of data mining of the user's remote Facebook profile data, remote Twitter usage data, and/or remote e-mail history data from a cloud-based email service. Additionally, in at least some embodiments, the client software module 258 may be configured to track certain user interactions with the client device 250. For example, the client software module 258 may recognize that a user visits the retail outlet of a participating advertising provider or the provider's competitor, and may track such visits irrespective of whether a location history is otherwise stored on the client device 250.

Because data mining and determinations of user eligibility for particular promotional packages are performed on the client device 250 in the illustrated embodiment, another benefit of the described techniques is that the client software module 258 may be able to increase the relevance of offers presented to the user over time, such as by automatically learning preference information for the user. For example, if a male user repeatedly declines to act upon offers for products of interest to female consumers for which the male user qualifies, the client software module 258 may be configured to ignore promotional packages related to such offers in the future. Furthermore, in certain embodiments, a user associated with a client device 250 may be enabled to predetermine or dynamically select categories of offers or advertising providers that should be ignored by the client software module 258 as part of its filtering operations, or alternatively which the user would specifically prefer to receive.

In certain embodiments, promotional packages may be provided by the promotional package manager module 240 in separate and distinct portions, such as for particular promotional packages that are configured to be multi-part promotional packages, or instead for any promotional package. For example, a first portion of a particular promotional package may be provided in a time and manner such as discussed elsewhere, for example in response to one or more precipitating events. The first portion of the package may include only limited information related to the offer associated with the complete promotional package—e.g., an indication of the advertising provider, or retail outlet related to the offer, or an indication of a particular category (such as clothing, beverages, electronics, etc.). Depending on the historical or explicit preferences established by the user associated with the client device 250, the client software module 258 may either ignore the first portion of the promotional package (such as when the first portion of the package indicates the associated offer is from a retailer or of a category in which the user is uninterested), or may issue a request that the remaining portion of the promotional package be provided. In this manner, the limited power, bandwidth and data usage available to certain client mobile computing devices 250 may be impacted to a lesser degree than otherwise possible.

In at least some embodiments, the client software module 258 may modify some or all of its functionality depending on aspects and parameters of the client mobile computing device 250. For example, a battery of a client mobile device may be preserved or enhanced in various manners, including to perform certain operations only when the mobile device is plugged in to an electricity source or otherwise has at least a minimum amount of battery life available, such as to only retrieve or accept promotional packages when the client device 250 satisfies triggering criteria involving exceeding a certain threshold percentage of battery power (e.g., when the battery is fully charged, or more than 50% charged). Similarly, the client software module 258 may delay any attempts to determine whether an associated user qualifies to receive any offers until one or more triggering criteria are satisfied, such as if a certain battery power threshold is achieved, on particular days, times of day, or other parameters. In other embodiments, other computing-related resources of a client mobile device may be preserved or enhanced in other manners, such as use triggering criteria to determine to perform certain network operations only when the mobile device has access to particular network connections (e.g., a Wi-Fi connection and/or a cabled/wired connection, but not a cellular service network; at particular times; at particular locations; etc.). In certain embodiments, these modifications to functionality may be explicitly configurable by a user associated with the client device 250; in other embodiments, such modifications may be provided by the promotional content server system 200 as part of initial or subsequent configuration of the client software module 258.

Each of the client mobile computing devices 250 is typically associated with a single distinct user (not shown), but embodiments are possible in which a single user is associated with multiple client devices 250, and also in which a single client device is associated with two or more human users. For example, a user may intentionally associate themselves with more than one client device 250 in order to raise the chances that her actions with respect to the multiple client devices may qualify her for particular rewards associated with particular offers. In certain embodiments, the user may “link” an instance of client software module 258 on each of multiple client devices 250 (e.g., by providing the same association code to each such instance, such as a unique identifier corresponding to the user, as may be generated or otherwise provided by the client software module and/or promotional package manager module). For example, a user may conduct financial transactions and maintain their financial data on a first client device 250, but may generally only carry a second client device when the user travels certain distances. In this manner, the user may receive a promotional package based on the location of the second client device 250 while shopping near an advertising provider's retail outlet, but may only qualify to receive the offer associated with that promotional package based on the financial transaction history present on the first client device. If the user has linked the first and second client devices, the client software module 258 executing on the second client device may provide an indication of the offer to the user (based on the financial transaction history stored on the first client device) while the user is still near the retail outlet and able to redeem any associated rewards.

In certain embodiments, a user may provide the promotional package manager module 240 or the client software module 258 with an indication of an alternative display device (not shown) to be used to receive indications of offers for which the user qualifies. For example, a user may prefer to receive an indication of such offers on the user's home computer, television, tablet or other display device to which the user has access. In this way, while the client software module 258 may determine that the user qualifies for one or more offers associated with promotional packages received and stored on the client device 250, the client software module provides an indication of those offers and their associated rewards on the alternative display device, either in addition or in lieu of providing the relevant indications on a display device associated with the client device 250 (e.g., display 271).

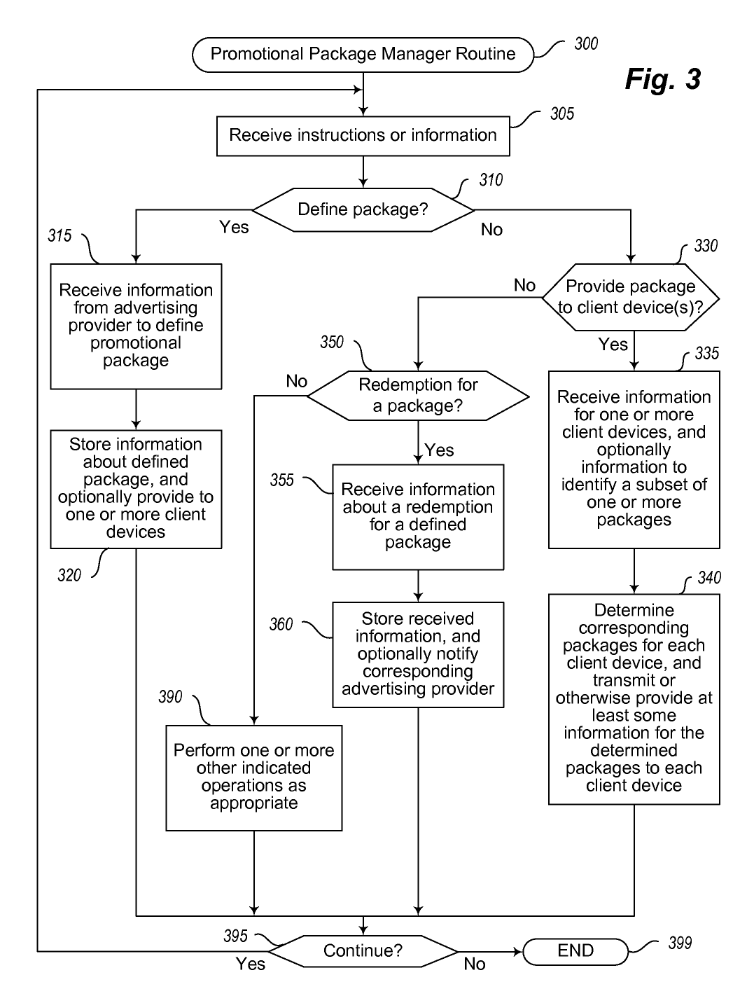

FIG. 3 is a flow diagram of an example embodiment of a Promotional Package Manager routine. The routine may be provided by, for example, execution of the Promotional Package Manager module 110 of FIG. 1 and/or of the Promotional Package Manager module 240 of FIG. 2, such as to manage the creation of defined promotional packages for advertising providers and the providing of defined promotional packages to client devices.

The illustrated embodiment of the routine begins at block 305, where instructions or information are received. The routine continues to block 310 to determine whether instructions or information have been received that are related to defining a new promotional package, such as from an advertising provider computing system or user. If so, the routine continues to block 315 to receive information from the advertising provider system or user to define a promotional package, and in block 320 stores information about the defined package for later use. The routine may optionally, in block 320, further determine to provide information about the new defined promotional package to one or more client devices, such as to push the new defined package to all available client devices, to a subset of client devices that satisfy one or more specified conditions (e.g., based on known or suspected locations of client devices), etc. In addition, in some embodiments the information about the defined package that is stored and/or provided to client devices is encrypted or otherwise encoded in one or more manners to prevent unauthorized access to some or all information about the defined package, as discussed in greater detail elsewhere. It will be appreciated that the operations of blocks 315 and 320 may be performed in various manners in various embodiments. For example, the receiving of the information in block 315 may include a series of actions by a user of an advertising provider who is interacting with a GUI provided by the routine 300, or instead may involve one or more invocations by a computing system of an advertising provider of an API provided by the routine 300. In other situations, an advertising provider may create a defined promotional package without interactions with the routine 300, and then send it to the routine 300 for storage and subsequent use.

If it is instead determined in block 310 that received instructions or information were not to define a new promotional package, the routine continues instead to block 330 to determine whether to provide one more defined promotional packages to one or more client devices. If so, the routine continues to block 335 to receive information corresponding to one or more client devices (e.g., information to enable communication with a client device, regardless of whether any identifying information is available about the client device and/or its user). In some embodiments, the routine may further receive information to optionally identify a subset of one or more available defined promotional packages, such as based on information corresponding to a location of the client device, categories or other areas of interest to a user of the client device, non-specific demographic information for the user of the client device, information about a type and/or capabilities of the client device, etc., while in other embodiments some or all such information may not be received or used in this manner. After block 335, the routine continues to block 340 to determine zero or more corresponding defined promotional packages for each client device indicated in block 335, and to transmit or otherwise provide at least some information for the determined corresponding packages to each such client device. It will be appreciated that the operations related to blocks 330 to 340 may be performed in various manners in various embodiments. For example, the indication to provide packages in block 330 may be a request from a client device for such information, or may instead be an automated determination by the routine 300 (e.g., periodically, upon occurrence of an event or other specified conditions, etc.) to proactively send such information to one or more client devices.

If it is instead determined in block 330 that the received instructions or information are not related to providing one or more defined promotional packages to one or more client devices, the routine continues instead to block 350 to determine whether instructions or information have been received related to redemption or other use of a defined promotional package, such as from a retailer associated with a promotion (e.g., the advertising provider who created the defined promotional package) and/or from a client device via which such redemption or other use occurred. If so, the routine continues to block 355 to receive the information about the redemption or other use for a defined package, and in block 360 stores the received information. If the information is not received from an advertising provider that created the defined promotional package, the routine may further optionally notify that advertising provider about the redemption or other use of the defined package. As discussed in greater detail elsewhere, the routine 300 may receive information about events corresponding to defined promotional packages and client devices at various time in various embodiments, such as to include one or more of the following: when a user of a client device is determined to be eligible for a defined promotional package, when a user of a client device receives information about determined eligibility of a particular defined promotional package, when a user of a client device requests additional information or otherwise selects an eligible defined promotional package without initiating its redemption or other use, when a user initiates redemption or other use of an eligible defined promotional package, etc.

If it is instead determined in block 350 that the received instructions or other information in block 305 is not related to redemption or other use of a defined promotional package, the routine continues instead to block 390 to perform one or more other indicated operations as appropriate. For example, as discussed in greater detail elsewhere, the routine may in some embodiments perform activities related to one or more of the following: registering advertising providers and/or users and/or client devices, such as to receive information about their entities and/or intra-relationships (e.g., one or more client devices that are associated with a particular user, one or more client devices that are associated with each other, etc.); receiving and responding to instructions or other information from an advertising provider to modify an existing defined promotional package, including to suspend or stop use of such a defined promotional package (e.g., if a number of possible redemptions or other uses of the defined promotional packages is determined by the advertising providing to have occurred); managing defined redemption or other use limits for particular defined promotional packages, such as with respect to information received for blocks 350-360; analyzing information about defined promotional packages and their uses, such as to generate aggregate metric information; performing subsequent portions of multi-part downloads or other providing of information for a particular defined promotional package, such as in response to an indication from a client device that eligibility criteria for a particular defined promotional package has been satisfied and/or that a user has been provided with or selected an eligible defined promotional package; etc.

After blocks 320, 340, 360, or 390, the routine continues to block 395 to determine whether to continue, such as until an explicit indication to terminate is received. If it is determined to continue, the routine returns to block 305, and if not continues to block 399 and ends.

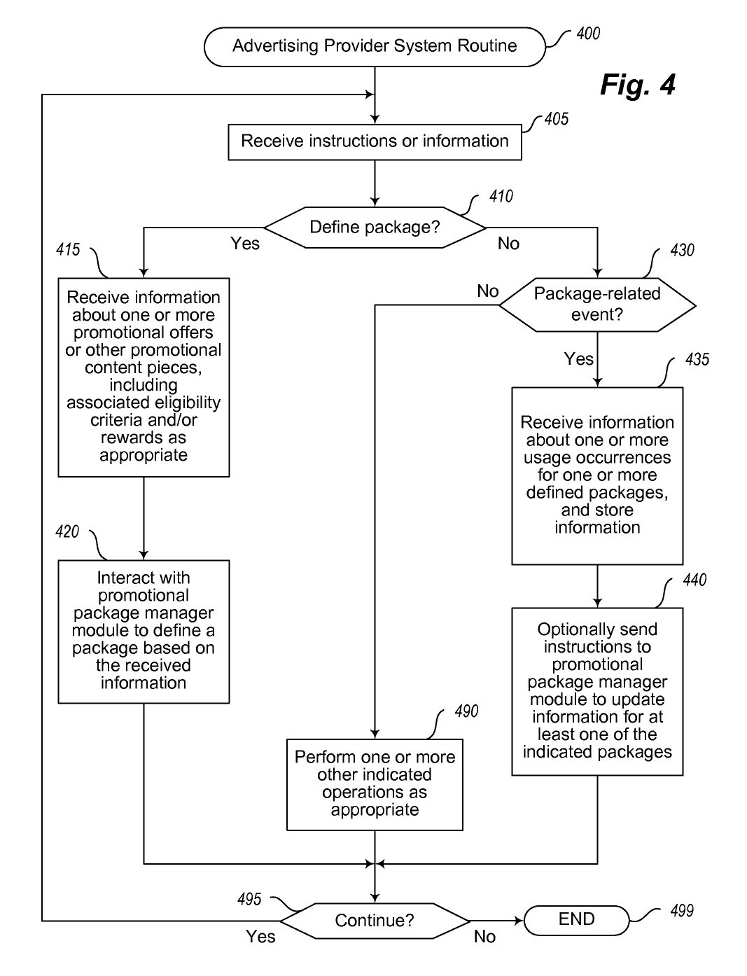

FIG. 4 is a flow diagram of an example embodiment of an Advertising Provider System routine. The routine may be provided by, for example, execution of an advertising provider computing system 140 of FIG. 1 and/or an advertising provider computing system 260 of FIG. 2, such as under instructions from one or more users of such a system, in order to define and manage promotional packages and to receive corresponding information related to their redemption and use.

The illustrated embodiment of the routine begins at block 405, where instructions or information is received. The routine then continues to block 410 to determine whether the instructions or information are related to defining a new promotional package. If so, the routine continues to block 415 to receive information about one or more promotional offers or other promotional content pieces, including associated eligibility criteria and rewards as appropriate. In some embodiments, additional information may be provided as discussed in greater detail elsewhere, such as an encoding scheme for use in generating a redemption token or other use indicator on a client device or otherwise by the promotional package manager module. After block 415, the routine continues to block 420 to interact with the promotional package manager module to define a promotional package based on the received information, including in some situations to create a defined promotional package that includes multiple alternative promotional offers or other promotional content pieces if so specified by the advertising provider. It will be appreciated that the actions at blocks 415 and 420 may be performed in various manners in various embodiments, including to perform one or more interactions by a user of the advertising provider system with a GUI provided by the promotional package manager module on a remote system or instead by software executing on the advertising provider system, by performing one or more programmatic invocations of an API provided by the promotional package manager module, etc. While the defined promotional packages are illustrated in this example as being generated one at a time in a serial manner, it will be appreciated that the defined promotional packages may be generated in other manners in other embodiments.

If it is instead determined in block 410 that the instructions or other information received in block 405 are not to define a new promotional package, the routine continues instead to block 430 to determine whether the instructions or information correspond to a package-related event. If so, the routine continues to block 435 to receive information about one or more usage occurrences or other events related to one or more defined packages, and to store that information. In block 440, the routine then optionally sends instructions to the promotional package manager module to update information for at least one of the indicated defined promotional packages, such as in response to instructions from a user or an automated determination to modify or suspend use of a defined promotional package. It will be appreciated that the types of events for which information may be received in block 435 may be of various types in various embodiments and situations, as discussed in greater detail elsewhere, including redemption of promotional offers and other uses of promotional content.

If it is instead determined in block 430 that the received instructions or information in block 405 do not correspond to a package-related event, the routine continues instead to block 490 to perform one or more other indicated operations as appropriate. For example, in some embodiments and situations, an advertising provider system may provide information about one or more defined promotional packages directly to some or all client devices in specified situations, such as in response to requests from the client devices for the defined promotional packages, by using a transmission device (e.g., a Wi-Fi router) at a retail location corresponding to the advertising provider, etc. Other examples of operations that may be performed with respect to block 490 include responding to requests from a user of an advertising provider for information about defined promotional packages and/or their use, performing analysis of aggregated redemption or other use of one or more defined promotional packages, etc.

After blocks 420, 440, or 490, the routine continues to block 495 to determine whether to continue, such as until an explicit indication to terminate is received. If it is determined to continue, the routine returns to block 405, and otherwise continues to block 499 and ends.

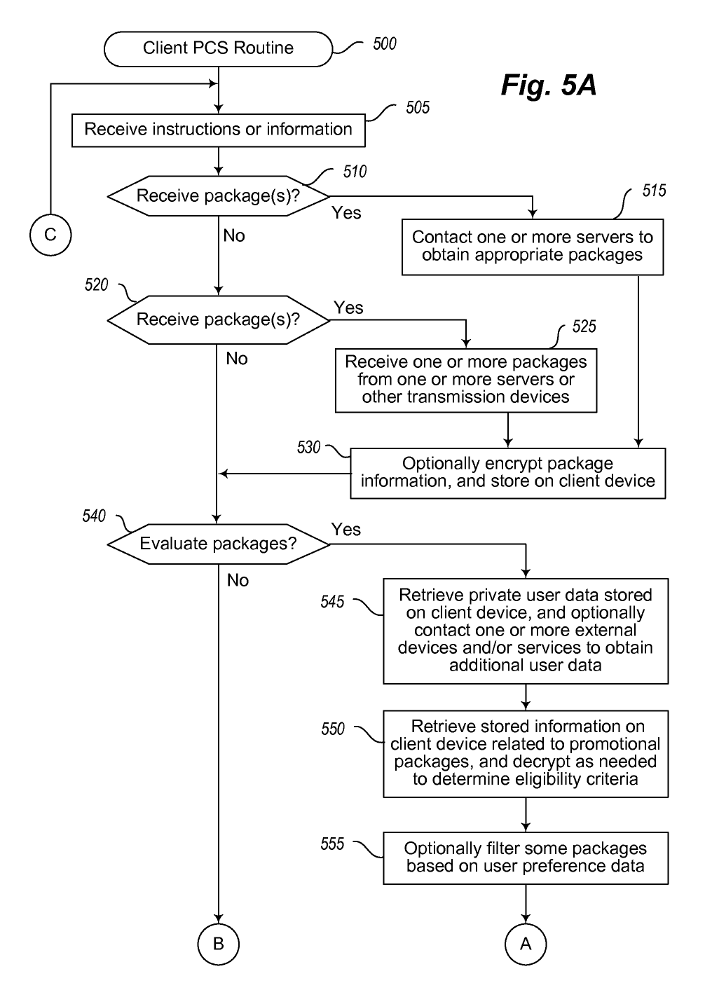

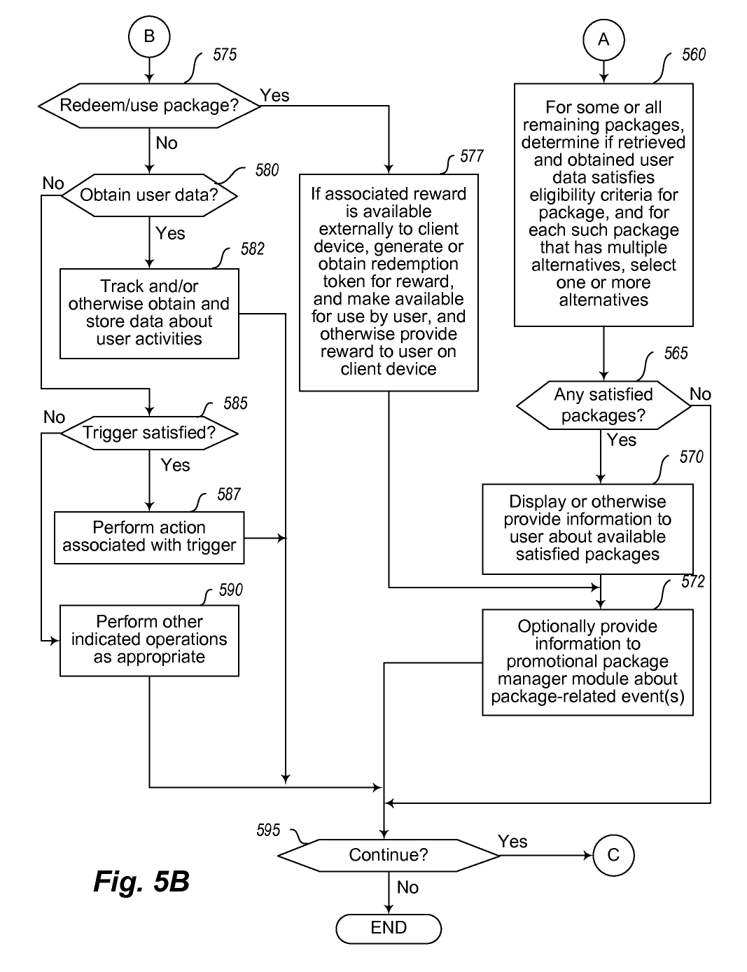

FIGS. 5A-5B are a flow diagram of an example embodiment of a Client PCS routine. The routine may be provided by, for example, execution of a client software module 135 of FIG. 1 on a particular client device and/or a client software module 258 of FIG. 2 on a particular client device, such as to determine eligibility of a user of the client device for available defined promotional packages based on private data for the user, and to provide corresponding information to the user about eligible promotional packages.

The routine begins at block 505, where instructions or information are received. The routine continues to block 510 to determine whether an indication to retrieve one or more defined promotional packages has been received, such as from a user of the device or instead based on an automated determination by the routine (e.g., periodically, as triggered by one or more triggering criteria being satisfied, etc.). If so, the routine continues to block 515 to contact one or more server systems to obtain appropriate defined promotional packages, such as to contact the promotional package manager module and/or one or more advertising provider systems. If it is instead determined in block 510 that the received instructions or information in block 505 are not to retrieve one or more defined promotional packages, the routine continues instead to block 520 to determine whether one or more defined promotional packages have been provided to the routine, such as if those packages are sent to the routine by an external server or other transmission device. If so, the routine continues to block 525 to receive such defined promotional packages. After blocks 515 or 525, the routine continues to block 530 to optionally encrypt or otherwise encode the package information, and to store the package information on the client device for later use.

After block 530, or if it is instead determined in block 520 that the received instructions or information in block 505 are not to receive a promotional package, the routine continues to block 540 to determine whether to evaluate one or more available promotional packages for eligibility by the user, such as in response to a request from the user and/or based on an automated determination by the routine (e.g., periodically, based on one or more triggering criteria being satisfied, etc.). If so, the routine continues to block 545 to retrieve private user data stored on the client device, and to optionally contact one or more external devices and/or network accessible services to obtain additional user data. As discussed in greater detail elsewhere, such private user data may be maintained on the client device in a manner that is not accessible externally to other entities, including to advertising providers and/or the promotional package manager module. In addition, the retrieval of the private user data may be performed in various manners, including to interact with other applications that execute on the mobile device to obtain application-specific data (e.g., using application-specific adapters to obtain data in a manner specific to the application), to interact with other external devices that are linked to the current device (e.g., other devices that are also used by the user), to interact with external services provided by third parties (e.g., social networking sites, financial institutions, etc.), etc. After block 545, the routine continues to block 550 to retrieve stored information on the client device related to available promotional packages, and to decrypt or otherwise decode the stored information as needed to determine the eligibility criteria for those promotional packages. As discussed in greater detail elsewhere, in some embodiments the eligibility criteria may not be encrypted or otherwise protected, while other information about the promotional offer or other promotional content may be encrypted or otherwise protected, and in some situations the information that is initially received and stored for a multi-part defined promotional package may include only a portion of the information for that promotional package (e.g., only the eligibility criteria).

After block 550, the routine continues to block 555 to optionally filter some of the available promotional packages based on information specific to the user, such as previously specified user preference information, current user location, etc., although in other embodiments such client-side filtering may not be performed. The routine then continues to block 560 to, for some or all of the remaining packages after any such filtering, determine if the retrieved and obtained user data satisfies the eligibility criteria for the packages to enable the packages to be made available to the user. In addition, for any packages that have multiple alternative promotional offers or other promotional content pieces, the routine may further select one or more of those alternatives to make available to the user, as discussed in greater detail elsewhere. After block 560, the routine continues to block 565 to determine whether any of the available defined promotional packages were determined to be satisfied, and if so continues to block 570 to display or otherwise provide information to the user about the available satisfied packages (including for packages with multiple alternatives, about the selected alternatives). In other embodiments and situations, such as depending on the type of defined promotional package, the routine may automatically accept a particular defined promotional offer or other defined promotional content piece on behalf of the user without performing the display or other providing of information, such as based on previously specified user preferences or instructions, and with the corresponding rewards for those accepted defined promotional packages being subsequently made available to the user.

If it is instead determined in block 540 that the received instructions or information in block 505 are not to evaluate available promotional packages, the routine continues instead to block 575 to determine whether the instructions or information indicate to currently redeem or otherwise access or use an eligible promotional package, such as based on a selection or other indication by the user of information previously provided to the user with respect to block 570. If so, the routine continues to block 577 to, in at least some situations in which the associated reward for the indicated eligible promotional package is available externally to the client device, generate or otherwise obtain a redemption token for use and obtaining the reward corresponding to the promotional package, and to make the redemption token available for use by the user to obtain the reward. As discussed in greater detail elsewhere, in some situations the redemption token may be displayed to the user, and used by the user at a corresponding retail location, while in other embodiments the redemption token may be stored on the device and used for redemption without display to the user (e.g., based on a transmission from the client device to a computing device at a retail location). In a situation in which the accepted eligible promotional package includes rewards that are available within or via the client device, such as to provide access to content and/or functionality to the user on the client device, the routine proceeds to make the corresponding reward for the promotional package available to the user on the client device without generating the redemption token. As discussed in greater detail elsewhere, in some embodiments the functionality of blocks 570 and/or 577 may include interactions between multiple client devices of a user, such as to make a determination of eligibility on one device and to display or otherwise provide information to the user about the eligible promotional package on another device, or to receive an indication from the user of a selection of an eligible promotional package on one device and to use another device to provide access to the corresponding reward to the user. In addition, in at least some situations involving multi-part defined promotional packages, the operations in blocks 560, 570 and/or 577 may include dynamically obtaining additional portions of a particular multi-part defined promotional package.

After blocks 570 or 577, the routine continues to block 572 to optionally provide information to the promotional package manager module corresponding to the package-related events that have occurred in blocks 560, 570, and/or 577, such as the determination of eligibility of the user for a defined promotional package, the display or other provision of information to the user about user eligibility for a particular promotional package, and the redemption or other use of an eligible defined promotional package on behalf of or by the user.

If it is instead determined in block 575 that the received instruction or other information in block 505 is not to redeem or otherwise make use of an eligible promotional package, the routine continues instead to block 580 to determine whether an indication is received to currently obtain user data, such as on a periodic basis, in response to a transaction or other action performed by the user, based on receiving data sent by another application executing on the client device, etc. If so, the routine continues to block 582 to track or otherwise obtain and store data about the user activities, including in some situations to periodically determine and store location information for the user, as discussed in greater detail elsewhere. In addition, while not illustrated here, in some embodiments the routine may further analyze private user data about prior user activities in order to determine particular user behavior from the prior user activities, such as in blocks 582 and/or 590 (e.g., to determine types of user behavior without regard to any particular defined promotional package), blocks 545, 560 and/or 590 (e.g., to determine whether a particular user behavior exists, such as based on that user behavior being specified in a particular defined promotional package being evaluated), for use in the eligibility determination activities of block 560.

If it is instead determined in block 580 that the instruction or other information received in block 505 is not to obtain user data, the routine continues instead to block 585 to determine whether an indication is received that one or more defined triggering criteria have been satisfied. If so, the routine continues to block 587 to perform one or more actions associated with the triggering criteria, such as to request or otherwise receive one or more defined promotional packages (e.g., by monitoring for a transmission of one or more available promotional packages). As discussed in greater detail elsewhere, such triggering criteria may be defined and configured in various manners in various embodiments.

If it is instead determined in block 585 that the instruction or other information received in block 505 is not an indication of satisfaction of one or more triggering criteria, the routine continues instead to block 590 to perform one or more other indicated operations as appropriate. For example, such other operations may include one or more of the following: obtaining and storing user preference information with respect to types of promotional offers or other promotional content of interest (e.g., for use with respect to filtering activities in block 555); receiving and storing triggering criteria information (e.g., from the user, from the promotional package manager module, etc.); analyzing available user data (e.g., perform data mining activities or other analysis or aggregation of available user data); retrieving user data from external sources (e.g., on a periodic basis, such as in a manner similar to that described with respect to block 545, in order to enable such additional information to be available at a time of eligibility determination with respect to block 560); etc.

After blocks 572, 582, 587, or 590, or if it is instead determined in block 565 that no packages' eligibility criteria was satisfied, the routine continues to block 595 to determine whether to continue, such as until an explicit indication to terminate is received. If it is determined to continue, the routine continues to block 505, and otherwise continues to block 599 and ends.

It will also be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, it will be appreciated that in other embodiments the operations may be performed in other orders and in other manners. It will also be appreciated that the data structures discussed above may be structured in different manners, including with respect to database data structures and Web page data structures, such as by having a single data structure split into multiple data structures or by having multiple data structures consolidated into a single data structure. Similarly, in some embodiments, illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited by the exemplary details. In addition, while certain aspects of the invention may be now or later presented in certain claim forms, the inventors contemplate the various aspects of the invention in any available claim form. For example, while only some aspects of the invention may be initially recited as being embodied in a computer-readable medium, other aspects may likewise be so embodied.

What is claimed is:

1. A computer-implemented method comprising:
receiving, by one or more configured processors of a mobile computing device, information about multiple promotional packages that are sent from at least one remote computing server of an advertising system, each promotional package having an associated promotional offer and having information that includes associated eligibility criteria for that associated promotional offer and one or more associated rewards for that associated promotional offer;
encrypting the information about the multiple promotional packages, and storing the encrypted information on the mobile computing device to prevent any unauthorized access to the information about the multiple promotional packages;
retrieving, by the one or more configured processors of the mobile computing device, private data stored on the mobile computing device related to prior activities of a first user of the mobile computing device, the prior activities including one or more of a history of commercial transactions of the first user and of a history of locations of the first user;
analyzing, by the one or more configured processors of the mobile computing device, the retrieved private data to determine one or more patterns of prior behavioral activities of the first user;
determining, by the one or more configured processors of the mobile computing device, and for each of the multiple promotional packages, whether the first user qualifies for the associated promotional offer of the promotional package based on whether the determined one or more patterns of prior behavioral activities of the first user satisfy the associated eligibility criteria for that promotional offer, the determining including decrypting at least some of the stored encrypted information and being performed without making any of the retrieved private data or information about the determined patterns of prior behavioral activities accessible externally to the mobile computing device; and
for each of the multiple promotional packages, if it is determined that the first user does not qualify for the associated promotional offer of the promotional package, preventing the first user from obtaining access to any information about the associated promotional offer of the promotional package, and if it is determined that the first user does qualify for the associated promotional offer of the promotional package:
generating, by the one or more configured processors of the mobile computing device, a redemption token for use by the first user in obtaining the one or more associated rewards for the associated promotional offer of the promotional package; and
displaying, by the one or more configured processors of the mobile computing device, the generated redemption token to the first user on the mobile computing device.

2. The method of claim 1 wherein the retrieved private data includes both of the history of commercial transactions of the first user and the history of locations of the first user, wherein the determined one or more patterns of prior behavioral activities of the first user include a first pattern of multiple purchases of one or more products of one or more specified product types at one or more specified locations, and wherein the first user is determined to qualify for the associated promotional offer of a first promotional package of the multiple promotional packages based on the first pattern satisfying the associated eligibility criteria for the associated promotional offer of the first promotional package.

3. A computer-implemented method comprising:
receiving, by one or more configured processors of a mobile computing device of a first user, information about multiple promotional offers, the received information indicating, for each of the multiple promotional offers, one or more associated eligibility criteria for the promotional offer and one or more associated rewards for the promotional offer;
storing the received information on the mobile computing device in a manner that is not accessible to the first user;
retrieving, by the one or more configured processors of the mobile computing device, private data stored on the mobile computing device related to prior activities of the first user;
analyzing, by the one or more configured processors of the mobile computing device, the retrieved private data related to the prior activities of the first user in order to determine one or more prior behavioral activities of the first user;
determining, by the one or more configured processors of the mobile computing device, whether the first user qualifies for a first promotional offer of the multiple promotional offers based at least in part on whether the determined one or more prior behavioral activities of the first user satisfy the one or more eligibility criteria associated with the first promotional offer, the determining being performed without making the retrieved private data or information about the determined prior behavioral activities accessible externally to the mobile computing device; and
if it is determined that the first user qualifies to obtain access to the first promotional offer, displaying to the first user on the mobile computing device information that enables the first user to obtain the one or more rewards associated with the first promotional offer, and otherwise preventing the first user from obtaining access to the information that enables the first user to obtain the one or more rewards associated with the first promotional offer.

4. The method of claim 3 wherein it is determined that the first user qualifies to obtain access to the first promotional offer, and wherein the method further comprises generating, by the one or more configured processors of the mobile computing device, a redemption token for the first promotional offer and displaying the generated redemption token to the first user on the mobile computing device to enable the first user to obtain the one or more rewards associated with the first promotional offer.

5. The method of claim 4 wherein the first promotional offer is part of a first defined promotional package that further indicates a first encoding scheme for generating redemption tokens for the first promotional offer, and wherein the generating of the redemption token is performed using the first encoding scheme.

6. The method of claim 5 wherein the multiple promotional offers further include a second promotional offer that is part of a second defined promotional package distinct from the first defined promotional package, wherein the second defined promotional package includes configuration information for a second encoding scheme that is distinct from the first encoding scheme, wherein the one or more eligibility criteria associated with the second promotional offer are distinct from the one or more eligibility criteria associated with the first promotional offer, wherein it is determined by the one or more configured processors of the mobile computing device that the first user qualifies to obtain access to the second promotional offer based at least in part on the one or more eligibility criteria associated with the second promotional offer, and wherein the method further comprises generating, by the one or more configured processors of the mobile computing device, a second redemption token using the second encoding scheme for use in redeeming the second promotional offer.

7. The method of claim 3 wherein it is determined that the first user qualifies to obtain access to the first promotional offer, and wherein the method further comprises:
displaying to the first user on the mobile computing device the information that enables the first user to obtain the one or more rewards associated with the first promotional offer;
determining, by the one or more configured processors of the mobile computing device, that the first user does not qualify to obtain access to a second promotional offer of the multiple promotional offers based at least in part on the one or more eligibility criteria associated with the second promotional offer; and
preventing the first user from obtaining access to the one or more rewards associated with the second promotional offer based on the determining that the first user does not qualify to obtain the access to the second promotional offer.

8. The method of claim 7 wherein the first promotional offer and the second promotional offer are alternative promotional offers included within a single defined promotional package and have distinct associated eligibility criteria corresponding to distinct prior user behavioral activities of the first user.

9. The method of claim 3 wherein the first promotional offer and a second promotional offer of the multiple offers are alternative promotional offers included within a single defined promotional package and have distinct associated eligibility criteria corresponding to distinct prior user behavioral activities of the first user, wherein it is determined that the first user qualifies to obtain access to the first promotional offer, and wherein the method further comprises:
displaying to the first user on the mobile computing device the information that enables the first user to obtain the one or more rewards associated with the first promotional offer;
determining, by the one or more configured processors of the mobile computing device, that the first user does not qualify to obtain access to the second promotional offer based at least in part on the one or more eligibility criteria associated with the second promotional offer; and
preventing the first user from obtaining access to the one or more rewards associated with the second promotional offer based on the determining that the first user does not qualify to obtain the access to the second promotional offer.

10. The method of claim 3 wherein the method is performed by one or more software modules executing on the mobile computing device to configure the one or more processors, wherein the private data stored on the mobile computing device includes data generated by one or more application programs executing on the mobile computing device that are provided by one or more entities distinct from a first entity that provides the one or more software modules, and wherein the retrieving of the private data stored on the mobile computing device includes interacting with the one or more executing application programs using configuration information provided by the first entity that is specific to the one or more executing application programs.

11. The method of claim 3 wherein the method is performed by one or more software modules executing on the mobile computing device to configure the one or more processors, wherein the private data stored on the mobile computing device includes data generated by one or more application programs executing on the mobile computing device that are provided by one or more entities distinct from a first entity that provides the one or more software modules, and wherein the retrieving of the private data stored on the mobile computing device includes retrieving and decoding stored data generated from the one or more application programs by using configuration information provided by the first entity that is specific to the one or more application programs.

12. The method of claim 3 further comprising retrieving, by the one or more configured processors of the mobile computing device, additional private data that is related to the prior activities of the first user and that is stored externally to the mobile computing device, and wherein the determining of the one or more prior behavioral activities of the first user is further based in part on the additional private data, the retrieving of the additional private data including interacting with one or more other computing devices of the first user to obtain confidential data for the first user that is stored on the one or more other computing devices.

13. The method of claim 3 further comprising retrieving, by the one or more configured processors of the mobile computing device, additional private data that is related to the prior activities of the first user and that is stored externally to the mobile computing device, and wherein the determining of the one or more prior behavioral activities of the first user is further based in part on the additional private data, the retrieving of the additional private data including interacting with one or more user accounts of the first user that are provided by remote network-accessible computing systems to obtain confidential data for the first user that is associated with the one or more user accounts.

14. The method of claim 3 further comprising:
receiving information about one or more triggering criteria that are associated with one or more actions performable by the mobile computing device;
determining, by the one or more configured processors of the mobile computing device, that the one or more triggering criteria are currently satisfied; and
initiating, by the one or more configured processors of the mobile computing device, performance of the one or more actions.

15. The method of claim 14 wherein the one or more actions include monitoring for availability of one or more promotional packages from one or more sources external to the mobile computing device, wherein the triggering criteria are based at least in part on one or more of a current location of the mobile computing device and of a current time and of current operating characteristics of the mobile computing device, and wherein the initiating of the performance of the one or more actions includes downloading one or more promotional packages from the one or more sources external to the mobile computing device.

16. The method of claim 3 further comprising, before the determining of whether the first user qualifies for the first promotional offer:
filtering, by the one or more configured processors of the mobile computing device, one or more of the multiple promotional offers as not being of interest to the first user, the filtering being based at least in part on the retrieved private data, the filtered one or more offers not including the first promotional offer; and
and wherein the determining of whether the first user qualifies for the first promotional offer further includes determining, for each of the multiple promotional offers other than the filtered one or more offers, whether the first user qualifies for that promotional offer based on the one or more eligibility criteria associated with that promotional offer.

17. The method of claim 3 further comprising, for each of the multiple offers other than the first promotional offer:
determining, by the one or more configured processors of the mobile computing device, whether the first user qualifies for the promotional offer based at least in part on the one or more eligibility criteria associated with the promotional offer; and
if it is determined that the first user qualifies to obtain access to the promotional offer, providing information to the first user that enables the first user to obtain the one or more rewards associated with the promotional offer, and otherwise preventing the first user from obtaining access to information about the promotional offer.

18. The method of claim 3 wherein the receiving of the information about the multiple promotional offers includes at least one of the mobile computing device contacting a remote server system to request at least one of the multiple promotional offers, of the mobile computing device receiving at least one of the multiple promotional offers from a communication directed to the mobile computing device from a remote server system, and of the mobile computing device receiving at least one of the multiple promotional offers via a broadcast transmission sent by an external device.

19. The method of claim 3 wherein the stored received information on the mobile computing device is encrypted in a manner that is accessible by one or more software modules executing on the mobile computing device to configure the one or more processors.

20. The method of claim 3 wherein the received information for the first promotional offer includes the one or more associated eligibility criteria for the first promotional offer but does not include additional information associated with the first promotional offer, and wherein the method further comprises not obtaining the additional information unless it is determined that the first user qualifies to obtain access to the first promotional offer.

21. The method of claim 3 wherein the retrieved private data related to the prior activities of the first user includes data corresponding to at least one of prior commercial transactions of the first user and of prior locations of the first user.

22. The method of claim 3 wherein the retrieved private data related to the prior activities of the first user includes data corresponding to prior commercial transactions of the first user, to prior locations of the first user, and to prior interactions of the first user with the mobile computing device.

23. A non-transitory computer-readable medium having stored contents that configure a computing device to perform a method, the method comprising:
storing information about first promotional content on the configured computing device without providing a user of the configured computing device with access to the stored information, the first promotional content being associated with one or more prerequisite criteria and one or more rewards;
retrieving, by the configured computing device, private data stored on the configured computing device related to prior activities of the user;
determining, by the configured computing device, whether the user qualifies to obtain access to the first promotional content based at least in part on whether the prior activities of the user satisfy the one or more prerequisite criteria associated with the first promotional content, the automatic determining being performed without making the retrieved private data accessible externally to the configured computing device by any entities other than the user; and
if it is determined that the user qualifies for the first promotional content, providing to the user access to the one or more rewards associated with the first promotional content, and otherwise preventing the user from obtaining the access to the one or more rewards associated with the first promotional content.

24. The non-transitory computer-readable medium of claim 23 wherein the method further comprises analyzing, by the configured computing device, the retrieved private data related to the prior activities of the user and determining one or more prior behavioral activities of the user based on the analyzing, and wherein the determining of whether the prior activities of the user satisfy the one or more prerequisite criteria associated with the first promotional content includes determining that the determined one or more prior behavioral activities of the user satisfy the one or more prerequisite criteria.

25. The non-transitory computer-readable medium of claim 23 wherein the configured computing device is a mobile client device of the user, wherein the first promotional content is part of a defined promotional package that includes at least one promotional offer, wherein the one or more rewards associated with the first promotional content include a monetary benefit related to purchase of a product, wherein the one or more prerequisite criteria are eligibility criteria for the at least one promotional offer, wherein it is determined that the user qualifies for the first promotional content, and wherein the method further comprises using the mobile client device to provide the monetary benefit as part of a subsequent purchase of the product by the user.

26. The non-transitory computer-readable medium of claim 23 wherein the first promotional content includes digital content having at least one of digital media data and of executable software, wherein the one or more rewards associated with the first promotional content include access to the digital content, wherein the determining of whether the prior activities of the user satisfy the one or more prerequisite criteria associated with the first promotional content includes determining that the prior activities of the user from the retrieved data do satisfy the one or more prerequisite criteria associated with the first promotional content, and wherein the method further comprises providing to the user access to the digital content on the configured computing device.

27. The non-transitory computer-readable medium of claim 23 wherein the stored contents are instructions that, when executed, program the configured computing device to perform the method, and wherein the computer-readable medium is a memory of the configured computing device.

28. A system, comprising:
one or more processors;
one or more storage devices that store private data related to prior activities of a user of a mobile device and that store information about first promotional content in a manner that is inaccessible to the user, the first promotional content being associated with one or more eligibility criteria and one or more rewards; and
one or more modules that are configured to, when executed by at least one of the one or more processors, provide to the user conditional access to the first promotional content by:
retrieving the stored private data, and identifying at least one of the prior activities of the user from the retrieved private data;
determining whether the user qualifies to obtain access to the first promotional content based at least in part on whether the identified at least one prior activities of the user satisfy the one or more eligibility criteria associated with the first promotional content; and
if it is determined that the user qualifies to obtain access to the first promotional content, providing to the user access to the one or more rewards associated with the first promotional content, and otherwise preventing the user from obtaining the access to the one or more rewards associated with the first promotional content.

29. The system of claim 28 wherein the one or more processors and the one or more storage devices are part of the mobile device, and wherein the one or more modules includes software instructions for execution on the mobile device to configure the mobile device to perform the providing to the user of the conditional access to the first promotional content.

30. The system of claim 29 wherein the providing to the user of the conditional access to the first promotional content further comprises analyzing the retrieved private data related to the prior activities of the user and determining one or more prior behavioral activities of the user based on the analyzing, and wherein the determining of whether the prior activities of the user satisfy the one or more eligibility criteria associated with the first promotional content includes determining that the determined one or more prior behavioral activities of the user satisfy the one or more eligibility criteria.

31. The system of claim 29 wherein the first promotional content is part of a defined promotional package that includes at least one promotional offer, wherein the one or more rewards associated with the first promotional content include a monetary benefit related to acquisition of a product, wherein it is determined that the user qualifies for the first promotional content, and wherein the providing to the user of the conditional access to the first promotional content further comprises using the mobile device to provide the monetary benefit as part of a subsequent acquisition by the user of the product.

32. The system of claim 28 wherein the first promotional content includes digital content having at least one of digital media data and of executable software, wherein the one or more rewards associated with the first promotional content include access to the digital content, wherein the determining of whether the prior activities of the user satisfy the one or more eligibility criteria associated with the first promotional content includes determining that the prior activities of the user from the retrieved data do satisfy the one or more eligibility criteria associated with the first promotional content, and wherein the providing to the user of the conditional access to the first promotional content further comprises providing access to the digital content on the mobile device.

33. The system of claim 28 wherein the system comprises one or more server computing systems that provide the information about the first promotional content.

34. The system of claim 28 wherein the one or more modules consist of one or more means for performing the providing to the user of the conditional access to the first promotional content.
